(19) United States
(12) Patent Application Publication
(10) Pub. No.: US 2004/0123144 A1
(43) Pub. Date: Jun. 24, 2004

(54) Method and system for authentication using forms-based single-sign-on operations

(75) Inventors: Charles Siu-Cheung Chan, Stretton (AU); Brian Eaton, Alexandria, VA (US); Christopher J. Hockings, Burleigh Heads (AU); Anthony S.. Moran, Santa Cruz, CA (US); Michael A. Tuton, Brisbane (AU)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY

(21) Appl. No.: 10/324,498

(22) Filed: Dec. 19, 2002

(51) Int. Cl. H04L 9/00

(52) U.S. Cl. 713/201

(57) ABSTRACT

A method is presented for enabling single-sign-on functionality with applications that require user/client authentication using form documents. A server-side forms-based single-sign-on (FSSO) module resides between a back-end application and a user. The FSSO module is configured to scan for various incoming requests and outgoing responses that contain information that trigger the FSSO module to initiate a single-sign-on operation or to perform another action with respect to an ongoing single-sign-on operation. At some point in time, a back-end application sends or attempts to send an authentication form to the user in order to obtain authentication information for an authentication operation by the back-end application, and the FSSO module intercepts the back-end application's authentication process to act as an intermediate agent between the user and the back-end application. Assuming that the user has already been authenticated within the server-side computing environment, the FSSO module automatically logs a user into the back-end application.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for computer-to-computer authentication.

2. Description of Related Art

Enterprises generally desire to provide authorized users with secure access to protected resources in a user-friendly manner throughout a variety of networks, including the Internet. Although providing secure authentication mechanisms reduces the risks of unauthorized access to protected resources, the same authentication mechanisms may become barriers to user interaction with the protected resources. Users generally desire the ability to jump from interacting with one application to another application without regard to the authentication barriers that protect each particular system supporting those applications.

As users get more sophisticated, they expect that computer systems coordinate their actions so that burdens on the user are reduced. These types of expectations also apply to authentication processes. A user might assume that once he or she has been authenticated by some computer system, the authentication should be valid throughout the user's working session, or at least for a particular period of time, without regard to the various computer architecture boundaries that are almost invisible to the user. Enterprises generally try to fulfill these expectations in the characteristics of their operational systems, not only to placate users but also to increase user efficiency, whether the user efficiency is related to employee productivity or customer satisfaction, because subjecting a user to multiple authentication processes in a given time frame may significantly affect the user's efficiency.

Various techniques have been used to reduce authentication burdens on users and computer system administrators. These techniques are generally described as “single-sign-on” (SSO) processes because they have a common purpose: after a user has completed a sign-on operation, i.e. been authenticated, the user is subsequently not required to perform another authentication operation. The goal is that the user would be required to complete only a single authentication process during the user's session.

Generally, an enterprise provides access to many web applications, and many web applications prompt a user to complete an authentication process using forms, e.g., HyperText Markup Language (HTML) forms. Therefore, it would be advantageous to have a method and a system in which an enterprise can provide a single-sign-on experience for multiple web applications without modifying the forms-based authentication operations of those web applications.

### SUMMARY OF THE INVENTION

A method, apparatus, system, and computer program product are presented for enabling single-sign-on functionality with applications that require user/client authentication using form documents. In one embodiment, a proxy server resides between multiple back-end applications that are hosted at a given domain and a user of resources at that domain. The proxy server is configured to scan for various incoming requests and outgoing responses that contain information that trigger the proxy server to initiate a single-sign-on operation or to perform another action with respect to an ongoing single-sign-on operation. At some point in time, a back-end application sends or attempts to send an authentication form to the user in order to obtain authentication information for an authentication operation by the back-end application, and the proxy server intercepts the back-end application's authentication process to act as an intermediate agent between the user and the back-end application. Assuming that the user has already been authenticated within the proxy server's computing environment, the proxy server automatically logs a user into the back-end application in a single-sign-on fashion instead of allowing the authentication form to be presented to the user. In an alternative embodiment, a web server plug-in accomplishes a similar operation by trapping a login form to perform an authentication process on behalf of a user in a forms-based single-sign-on fashion.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 1C depicts a data flow diagram that illustrates a typical authentication process that may be used when a client attempts to access a protected resource at a server;

FIG. 1D depicts a block diagram that shows a typical transfer of an authentication form between a server and a client;

FIG. 2 depicts a block diagram that shows the interception of a form by a proxy server between a server and a client in accordance with the present invention;

FIG. 3 depicts a block diagram that shows a data processing system that supports forms-based single-sign-on operations in accordance with an embodiment of the present invention; and

FIG. 4 depicts a dataflow diagram that shows a forms-based single-sign-on process in accordance with an embodiment of the present invention;

FIG. 5 depicts a block diagram that shows an embodiment of the present invention in which a web server plug-in incorporates one or more modules for providing functionality for forms-based single-sign-on operations;

FIG. 6 depicts a dataflow diagram that shows the flow of information of a plug-in embodiment for the FSSO functionality.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

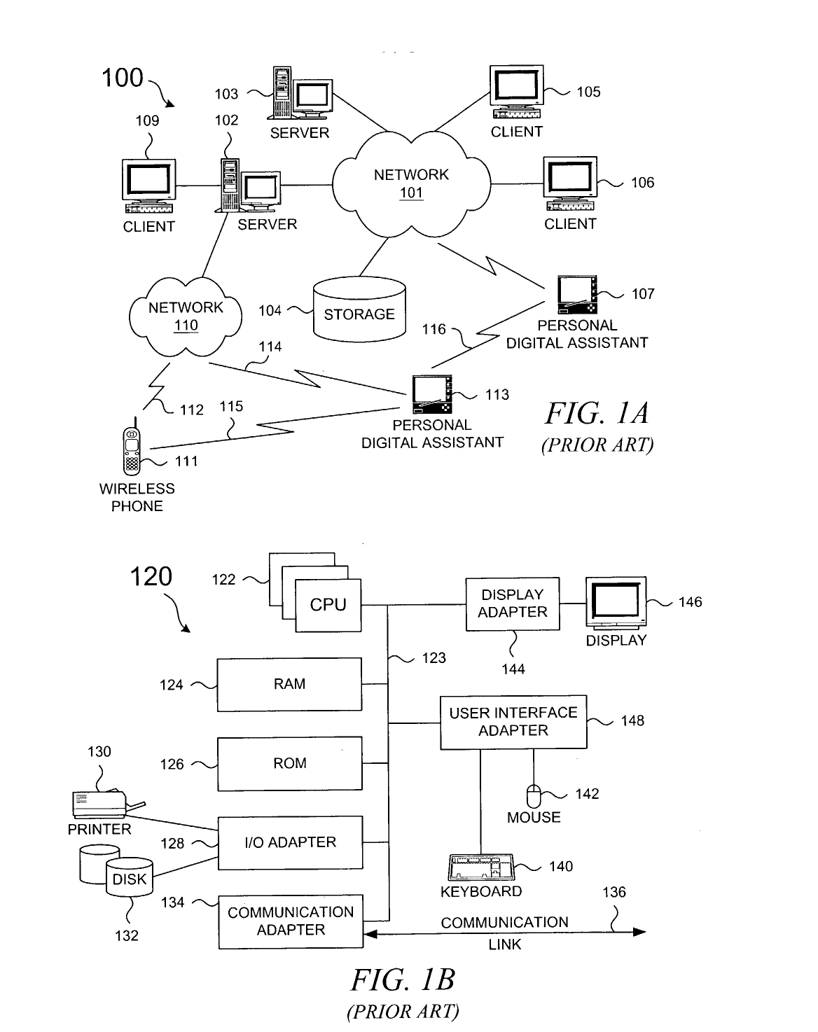

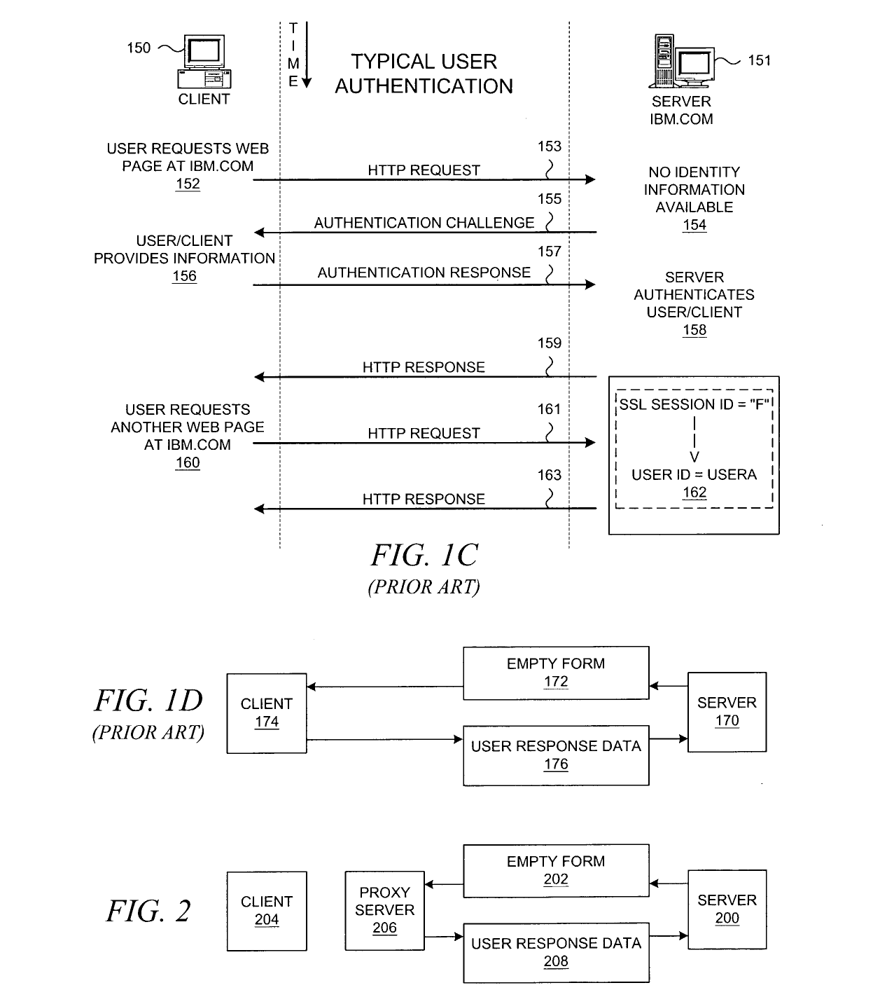

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as LDAP (Lightweight Directory Access Protocol), TCP/IP (Transport Control Protocol/Internet Protocol), HTTP (HyperText Transport Protocol), etc.. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks or personal ad-hoc networks. In a similar manner, PDA 113 can transfer data to PDA 107 via wireless communication link 116.

The present invention could be implemented on a variety of hardware platforms and software environments. FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, extensible Markup Language (XML), HyperText Markup Language (HTML), Handheld Device Markup Language (HDML), Wireless Markup Language (WML), and various other formats and types of files. It should also be noted that the distributed data processing system shown in FIG. 1A is contemplated as being fully able to support a variety of peer-to-peer subnets and peer-to-peer services.

With reference now to FIG. 1C, a data flow diagram illustrates a typical authentication process that may be used when a client attempts to access a protected resource at a server. As illustrated, the user at a client workstation 150 seeks access over a computer network to a protected resource on a server 151 through the user's web browser executing on the client workstation. A protected resource is a resource (an application, an object, a document, a page, a file, executable code, or other computational resource, communication-type resource, etc.) for which access is controlled or restricted. A protected resource is identified by a Uniform Resource Locator (URL), or more generally, a Uniform Resource Identifier (URI), that can only be accessed by an authenticated and authorized user. The computer network may be the Internet, an intranet, or other network, as shown in FIG. 1A or FIG. 1B, and the server may be a web application server (WAS), a server application, a servlet process, or the like.

The process is initiated when the user requests a server-side protected resource, such as a web page within the domain “ibm.com” (step 152). The terms “server-side” and “client-side” refer to actions or entities at a server or a client, respectively, within a networked environment. The web browser (or associated application or applet) generates an HTTP request that is sent to the web server that is hosting the domain “ibm.com” (step 153). The terms “request” and “response” should be understood to comprise data formatting that is appropriate for the transfer of information that is involved in a particular operation, such as messages, communication protocol information, or other associated information.

The server determines that it does not have an active session for the client (step 154), so the server requires the user to perform an authentication process by sending the client some type of authentication challenge (step 155). The authentication challenge may be in various formats, such as an HTML form. The user then provides the requested or required information (step 156), such as a user identifier and an associated password, or the client may automatically return certain information.

The authentication response information is sent to the server (step 157), at which point the server authenticates the user or client (step 158), e.g., by retrieving previously submitted registration information and matching the presented authentication information with the user's stored information. Assuming the authentication is successful, an active session is established for the authenticated user or client.

The server then retrieves the requested web page and sends an HTTP response message to the client (step 159). At that point, the user may request another page within “ibm.com” (step 160) within the browser by clicking a hypertext link, and the browser sends another HTTP request message to the server (step 161). At that point, the server recognizes that the user has an active session (step 162), and the server sends the requested web page back to the client in another HTTP response message (step 163), thereby fulfilling the user's original request for the protected resource.

With reference now to FIG. 1D, a block diagram depicts a typical transfer of an authentication form between a server and a client. As noted above in the description of FIG. 1C, users are often authenticated by applications through the use of a form. A form is a document that is presented to a user to request information from the user; after information is provided, which is typically input by a user or somehow selected by a user through a graphical user interface, the entered information is collected in some manner. In some instances, the form document could be modified to hold the responsive information. Often, as is assumed by the present invention, the responsive information is collected as a set of name/value pairs; each requested information item, sometimes referred to as a field, is identified by a name, and each user-specified value is associated with the appropriate named field. As shown in FIG. 1D, server 170 sends empty form 172 to client 174, which presents the form to a user. After receiving input data, client 174 sends form response data 176 to server 170, which extracts the user information. In the authentication challenge that is shown in FIG. 1C, an HTML form may be presented by a browser application at the client, and the user at the client may input a username and an associated password into the form. Upon a certain user action, the browser application returns the user response data to the authentication server, which retrieves the username and the password for verification through subsequent processing.

Given the description of FIGS. 1A-1D as background information, the description of the remaining figures relates to the present invention, which is directed to providing a single-sign-on (SSO) mechanism that can be integrated with existing or legacy applications that use form-based authentication mechanisms.

With reference now to FIG. 2, a block diagram depicts the interception of a form by a proxy server between a server and a client in accordance with the present invention. FIG. 2 depicts a brief summary of an embodiment of the present invention. In a manner similar to that shown in FIG. 1D, server 200 attempts to send empty form 202 to client 204. In contrast to FIG. 1D, the form is intercepted by proxy server 206, so the form is not received at the client and is not presented to a user of the client, e.g., via a browser application at the client. Instead, proxy server 206 returns response data 208 that is appropriate for the user to server 200 on behalf of the user. By acting on behalf of the user when certain forms-based operations are detected, a specialized single-sign-on environment is provided for certain scenarios that involve the processing of forms.

The descriptions of the figures herein involve certain actions by either a client device or a user of the client device. One of ordinary skill in the art would understand that responses and/or requests to/from the client are sometimes initiated by a user and at other times are initiated automatically by a client, often on behalf of a user of the client. Hence, when a client or a user of a client is mentioned in the description of the figures, it should be understood that the terms “client” and “user” can be used interchangeably without significantly affecting the meaning of the described processes.

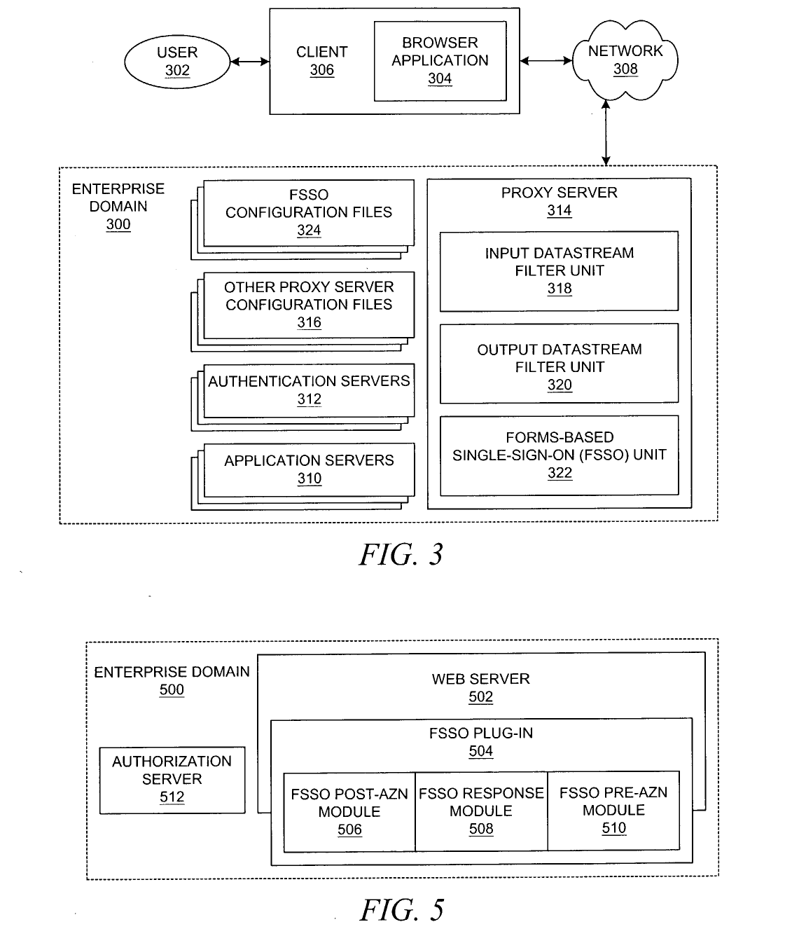

With reference now to FIG. 3, a block diagram depicts a data processing system that supports forms-based single-sign-on operations in accordance with an embodiment of the present invention. As in a typical corporate computing environment or an Internet-based computing environment, enterprise domain 300 hosts controlled resources that user 302 can access, e.g., by using browser application 304 on client 306 through network 308. Application servers 310 support accessible resources through web-based applications or other types of applications, including legacy applications. Authentication servers 312 support various authentication mechanisms, such as username/password, X.509 certificates, or secure tokens. A protected or controlled resource is a resource (an application, an object, a document, a page, a file, executable code, or other computational resource, communication-type resource, etc.) that is only accessed or retrieved if the requesting client is both authenticated and authorized. It should be noted that the following examples assume that a user is authorized to access all controlled resources after the user has been authenticated, but alternative embodiments may incorporate authorization processes without affecting the scope of the present invention.

Enterprise domain 300 supports multiple servers. Proxy server 314 performs a wide range of functions for enterprise domain 300. Proxy server 314 can be administratively configured through configuration files 316 to control the functionality of proxy server 314, e.g., caching web pages in order to mirror the content from an application server or filtering the incoming and outgoing datastreams through input datastream filter unit 318 and output datastream filter unit 320. Input datastream filter unit 318 may perform multiple checks on incoming requests while output datastream filter unit 320 may perform multiple checks on outgoing responses.

The above-noted entities within enterprise domain 300 represent typical entities within many computing environments. As was shown with respect to FIG. 1C, web-based applications can utilize various means to prompt users to enter authentication information, often as a username/password combination within an HTML form. In the example that is shown in FIG. 3, user 302 may be required to be authenticated before client 306 may have access to resources, after which a session is established for client 306 in a manner similar to that described above in FIG. 1C. In FIG. 3, after receiving an incoming request from client 306, input datastream filter unit 318 may determine whether client 306 has already established a session; if not, an authentication service on authentication servers 312 can be invoked in order to authenticate user 302. If client 306 has already established a session, then additional checks may be performed on an incoming request prior to granting access to a controlled resource.

Turning now to focus on an embodiment of the present invention, proxy server 314 has been extended to include the present invention, which is represented in FIG. 3 by forms-based single-sign-on unit 322, the functionality of which is configurable by a system administrator through the use of forms-based single-sign-on configuration files 324.

Hence, FIG. 3 shows an example of an embodiment of the present invention in the following manner. Proxy server 314 sits between multiple web application servers 310 that are hosted by domain 300 and user 302. User 302 desires to access resources that are provided by back-end applications that are hosted on web application servers 310. At some point in time, user 302 may send an initial resource request to a particular back-end application, which then attempts to send an HTML-formatted authentication form to user 302 in order to obtain authentication information for an authentication operation. In an improvement over prior art systems, forms-based single-sign-on unit 322 detects the authentication operation in the filtered incoming datastream; in a preferred embodiment that is described below in more detail, the user's incoming request to access a login web page/form may trigger the forms-based single-sign-on unit. Alternatively, forms-based single-sign-on unit 322 could detect the authentication operation in the filtered outgoing datastream.

In response, proxy server 314 performs actions with assistance from authentication servers 312 in an attempt to automatically log user 302 into the back-end application that sent the authentication form. If user 302 has already been authenticated in some manner within domain 300, then one of authentication servers 312 is able to provide authentication information or an authentication assertion for user 302; alternatively, the proxy server is able to retrieve such information itself without interaction with other servers. Proxy server 314 sends the required authentication information for the authentication form to the back-end application. Assuming that the authentication operations are completed successfully, then the user is signed onto the back-end application and provided access to its controlled resources.

It should be noted that the present invention should not be regarded as limited in the manner in which it may interact with various forms of authentication services for the management of a user's authentication information. In addition, it should be noted that forms-based single-sign-on filter unit 322 in FIG. 3 is merely an exemplary entity that assists in the functionality of the present invention. Alternative embodiments may have other configurations in which the present invention is contained within subroutines, methods, classes, procedures, etc., of different types of applications or servers. In addition, although the examples depict the use of HTTP messages and HTML pages, the present invention may be implemented to support other protocols and document formats.

The most significant advantage of the present invention is that the user/client is not presented with any additional authentication challenges. In fact, the user/client is unaware of the interactions between the proxy server and the back-end application. Moreover, a back-end application is not aware that something other than the user/client is providing the authentication information. Hence, back-end applications can be integrated with the single-sign-on functionality that is provided by the present invention because the back-end applications would ideally not require any modification. In addition, the back-end applications may continue to be accessed through other channels that use the authentication means of the back-end applications. A more detail description of the present invention is provided below with respect to the remaining figures.

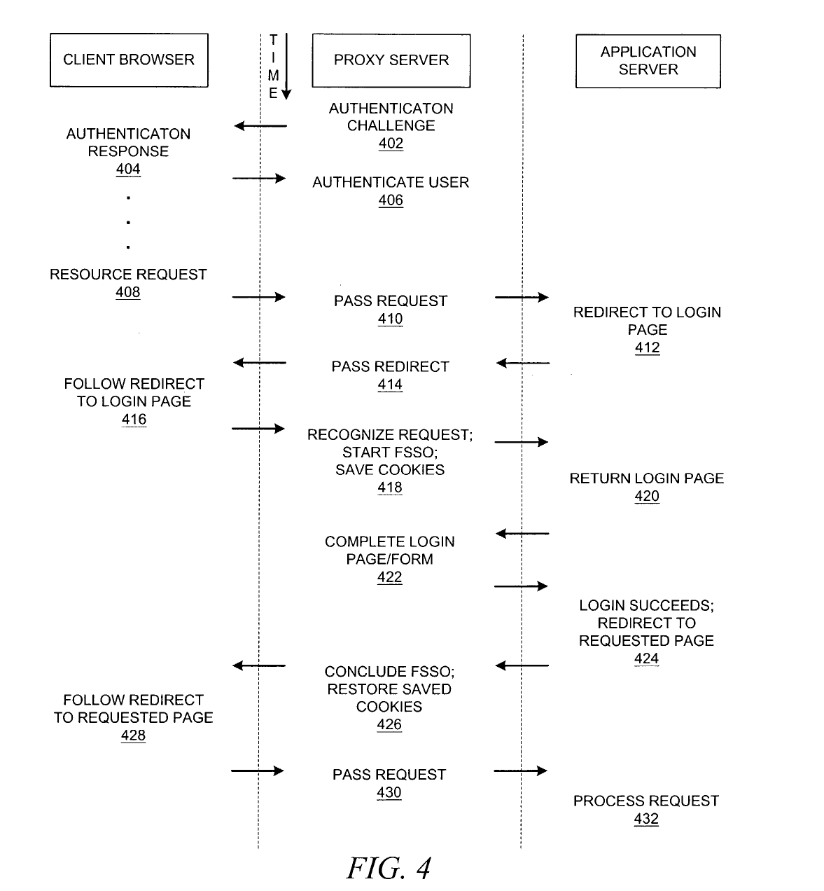

With reference now to FIG. 4, a dataflow diagram depicts a forms-based single-sign-on process in accordance with an embodiment of the present invention. FIG. 4 is similar to FIG. 1D in that both diagrams show an authentication process between a user and an application server that provides controlled access to resources. In contrast to FIG. 1D, however, FIG. 4 shows a proxy server that acts as an intermediate agent in order to provide a specialized single-sign-on environment.

The process in FIG. 4 begins with an abbreviated description of an initial authentication process. A proxy server sends an authentication challenge (step 402) to a browser application at a client device that is operated by a user, after which the client returns an authentication response (step 404). Assuming that the client has provided the correct response information, the proxy server authenticates the client (step 406).

The initial authentication operation in steps 402-406 may be initiated in response to a variety of actions by the client. For example, in an enterprise computing environment, the user may be required to complete an initial logon process before the user may operate the client in any manner whatsoever. In other cases, the user may access a specialized resource, particularly a special logon page, in anticipation of subsequent actions by the user within a computing environment for which the user knows that an authentication process would be required. This initial authentication operation may comprise a simple username/password response, as shown in FIG. 1D. However, more complex operations may be performed; for example, an authentication challenge may involve a secure hardware token that should only be in the possession of an authorized user, a biometric reading from an authorized user, the provision of secret information, e.g., username/password combination, that should only be known by an authorized, and/or other such procedures. Although the present invention does not require complex authentication procedures, one of ordinary skill in the art would understand that a prudently designed single-sign-on environment would require strong security procedures.

As noted above with respect to FIG. 3, the present invention may be implemented in cooperation with a wide variety of server-side authentication infrastructures. For example, the proxy server may operate in conjunction with one or more authentication servers. In addition, after the initial authentication operation, the proxy server may maintain information about the fact that a secure session has already been established for the client, or such information may be available for retrieval by the proxy server or on behalf of the proxy server. When the proxy server or some other server requires any other authentication information or the intervention of other authentication processes, it may be assumed that such resources are available to the servers through an appropriate authentication infrastructure. These types of well-known authentication resources are not further described in order to focus the description on the improvements provided by the present invention.

At some subsequent point in time after the initial authentication operation, the client sends a request for a particular resource (step 408), e.g., an HTTP request for a web page that is identified by a particular URL such as “https://www.ibm.com/formsso/content.html”. The proxy server filters the incoming request by scanning for certain information, as explained in more detail further below. If the proxy server determines that no additional actions are necessary based on the results of the input filter operation, then the proxy server passes the request to an appropriate back-end application based on the URL within the incoming request (step 410).

The back-end application processes the request and determines that the user must be authenticated by the back-end application prior to providing access to the requested resource. To initiate an authentication operation, the back-end application sends an HTTP redirection response to the client (step 412), e.g., to a particular logon web page; it should be understood that an embodiment of the present invention could be configured such that it is operable for back-end applications that do not initiate redirection responses. The proxy server filters the outgoing response by scanning for certain information, as explained in more detail further below. If the proxy server determines that no additional actions are necessary based on the results of the output filter operation, then the proxy server passes the redirection response to the client (step 414). The client follows the redirection by generating a request for the redirected URL (step 416), e.g., a web page such as “https://www.ibm.com/formsso/login.html”.

Up to this point, the proxy server has merely filtered the incoming and outgoing datastreams in a known fashion. However, the proxy server in this embodiment of the present invention has been configured to filter the incoming and outgoing datastreams for particular information.

When the proxy server receives the client's redirected request, the proxy server filters the incoming redirected request. Based on the results of the input filter operation, the proxy server recognizes the requested resource and initiates a forms-based single-sign-on operation (step 418), after which the proxy server forwards the request to the back-end application based on the URL within the incoming request.

The proxy server may be configured to recognize particular URLs as being directed to web pages that would initiate a logon operation for a back-end application. The proxy server obtains its filter parameters from information in a configuration file, which may contain lists of URLs that act as triggers, as explained in more detail further below.

When the forms-based single-sign-on operation is initiated, the proxy server may create a data structure entry or some other type of record for the operation. Appropriate context or state information is saved for this particular forms-based single-sign-on operation for this particular client, such as any HTTP cookies that were received from the client at the proxy server. A client may participate in many back-end application authentication operations during a single user session, although it may be expected that a client would not simultaneously participate in multiple forms-based single-sign-on operations.

The back-end application receives the incoming request, processes the request, and returns the requested logon web page/form (step 420). The proxy server filters the outgoing response by scanning for certain information. In accordance with configured filter parameters, the proxy server recognizes the logon form and parses the logon form to extract various information, such as the input fields in the form or any other information from the outgoing form that is necessary for the completion of the forms-based single-sign-on operation. The extracted information may include so-called hidden fields that would not have been presented to the user but are sometimes included in forms for the benefit of the back-end application in maintaining state information for the authentication operation with respect to a particular user. In a manner similar to that noted above for the incoming request from the client, it may again be necessary for the proxy server to save appropriate context or state information for this particular forms-based single-sign-on operation for this particular client, such as any HTTP cookies that were received with the logon form from the back-end application at the proxy server.

Using the information that is extracted from the form, the proxy server is able to retrieve the authentication information that is appropriate for the authentication form. For example, the proxy server is able to determine if a username/password combination is required by the authentication form. If so, then given the fact that the proxy server has already authenticated the user and has verified identity information for the user, the proxy server can retrieve the user's username/password information from an authentication database. In a similar manner, other types of information may be retrieved as required by the requested fields in the authentication form in accordance with the user's known identity. However, it should be noted that the forms-based single-sign-on operation could be configured to supply a standard, hardcoded username and password for all users, including users who have not been authenticated.

The proxy server then generates and returns an authentication response that is appropriate for the received authentication form and that contains the previously determined user's authentication information and possibly other context information for the user or this particular logon operation (step 422). The configuration files for the forms-based single-sign-on function may also guide the manner in which the proxy server should generate the response. For example, the configuration information may indicate the formatting that is required by a particular back-end application such that the back-end application is able to extract the required information.

If the proxy server is not able to successfully generate an authentication, then the proxy server may return an error to the user. The configuration files may also indicate an appropriate format for an error response for this operation. Alternatively, the proxy server may conclude the forms-based single-sign-on operation and forward the authentication form to the client so that the user/client directly completes the back-end application's authentication operation.

After receiving the authentication response from the proxy server, the back-end application verifies the authentication information that has been extracted from the authentication response. Assuming the authentication operation is successful, the back-end application then generates and sends another redirection response to the client (step 424). In this case, the redirection is to the originally requested resource, which in this example is “https://www.ibm.com/formsso/content.html”. Again, it should be understood that an embodiment of the present invention could be configured such that it is operable for back-end applications that do not initiate redirection responses.

The proxy server filters the outgoing response and recognizes that the client is being redirected to another resource (step 426). The proxy server may be configured to detect and respond to both successful and unsuccessful authentication results at the back-end application.

If the authentication process at the back-end application is not successful and the back-end application returns an error, then the proxy server may simply return the response from the back-end application to the client. Alternatively, the proxy server may be configured to detect such errors, and the proxy server may perform other actions in response to such errors. For example, the proxy server may have saved the authentication form from the back-end application, and if the proxy server's response was not successful, then in a manner similar to that noted above, the proxy server may conclude the forms-based single-sign-on operation and forward the authentication form to the client so that the user/client directly completes the back-end application's authentication operation. Alternatively, the proxy server could re-run the client's redirected request for the logon page while recording information that indicates that the proxy server should not attempt another forms-based single-sign-on operation for this user/client during this particular session. Other alternative error processing modes and responses may be implemented and supported within the present invention.

If the authentication process at the back-end application is successful, then the back-end application returns a response that either implicitly or explicitly indicates that the authentication response from the proxy server was successful. The proxy server may be configured so that the outgoing datastream filter is triggered by various response indications.

In any case, the proxy server begins to conclude the forms-based single-sign-on process. The proxy server retrieves any previously saved cookies from the stored context information for this particular forms-based single-sign-on process and combines them with any cookies that may be present in the redirection response. The proxy server may then deallocate any resources that were previously allocated for the client's logon process. The proxy server then forwards the redirection response to the client, which completes this particular forms-based single-sign-on process. In this manner, neither the client nor the back-end application is aware that a proxy server is acting as an intermediate agent, even though they are the beneficiaries of the forms-based single-sign-on process of the present invention.

Assuming that the forms-based single-sign-on operation has concluded successfully, the client receives the forwarded redirection response from the proxy server and follows the redirection to the originally requested web page (step 428). The proxy server filters the incoming redirected request, and since the proxy server is not triggered by any conditions in the configured input filter, the proxy server forwards the request for the page at “https://www.ibm.com/formsso/content.html” (step 430). The back-end application receives and then processes the request for the web page (step 432), thereby concluding the process that is shown in FIG. 4. During the forms-based single-sign-on process, the client sends three requests to the proxy server. From the user's perspective, however, only a single request has been made, and the other requests occur automatically through HTTP redirections.

Referring again to FIG. 3, the configuration files for the proxy server can be custom-created by a system administrator during a configuration phase. Alternatively, there may be a software utility that generates a configuration file based on information that is available about the behavior of one or more back-end applications. There may be one configuration file per back-end application, or a single configuration file could contain information that is associated with all supported back-end applications.

When the proxy server is initialized or instantiated, the proxy server would read the one or more configuration files into appropriate data structures such that the filter parameters/conditions can be quickly searched while the incoming and outgoing datastreams are scanned for matching information and/or conditions. Each entry within the configuration file would have a corresponding data structure entry in memory when the proxy server processes and loads the configuration file during its initialization phase. Each of the data structure entries is essentially a triggering condition for either an incoming datastream filter unit or an outgoing datastream filter unit, as described above with respect to FIG. 3.

For example, each URL, or more generally, each URI, for a login form at a supported back-end application may be indicated in an entry within a configuration file. Each of these URLs then becomes a data structure entry after the configuration file has been processed. As the incoming datastream filter scans the requested URLs in incoming HTTP requests from clients, the filter attempts to match the requested URLs with URLs that are associated with login forms/pages at back-end applications. When a match is detected, the filter can indicate the event to the proxy server, which then initiates a forms-based single-sign-on operation as described above.

In a similar manner, each of the structures or formats of forms, requests, and/or responses that are used as processing parameters within the proxy server may be similarly stored in a configuration file and then processed and placed in an appropriate data structure entry. It should be understood that the input/output triggers, data formats, conditions, etc., that are noted above should not be regarded as exhaustive with respect to the present invention, which flexibly supports a wide variety of configuration information; an example for such configuration information is provided hereinbelow.

The forms-based single-sign-on functionality can be configured using a stanza file. The stanza file can control which URIs are interpreted as forms-based single-sign-on URIs, what kind of parsing of login forms should be done, and how the response is generated.

Table 1 shows an example for a format for a configuration file. Although not shown, error status codes, expressions to match message headers associated with error pages, and/or paths to error pages that should be returned by a proxy server could also be specified.

TABLE 1

[forms-sso-login-pages]
login-page-stanza = <xxxxx>
#
[<xxxxx>]
login-page = <expression-page-match>
login-form-action = <expression-form-match>
sso-resource = <sso-target>
argument-stanza = <yyyyy>
#
<yyyyy>
<name> = <method>:<value>

The forms-based single-sign-on configuration file begins with the string “[forms-sso-login-pages]” stanza, which contains one or more “login-page-stanza” entries that point to other custom-named stanzas, which themselves contain configuration information for the login pages found on the back-end application server. The ability to support multiple login pages is useful because a single back-end server may host several applications that each use a different authentication method.

Each custom “login-page-stanza” is used to intercept a particular URI pattern and may contain multiple parameters. The “login-page” parameter specifies a pattern that uniquely identifies requests for an application's login page. Only one such parameter is permitted in each stanza. The proxy server intercepts these pages and then beings the forms-based single-sign-on process. An expression is compared against the request URI; it may be a relative URI, which allows the configuration file to be shared by multiple proxy servers in a replicated environment.

The “login-form-action” parameter specifies a pattern that identifies which form contained in the intercepted page is the application's login form. Only one such parameter is permitted in each stanza. Assuming that the authentication form from the back-end application is an HTML form, then the value of the “login-form-action” parameter is an expression that is compared against the contents of the “action” attribute of the HTML “form” tag. The “action” attribute is a URI that is expressed as a relative, server-relative, or absolute path. If there is only a single form in the page, or if the login form is the first form in the page, then the expression would be wild-carded. If multiple “action” attributes on the page match the expression, then only the first match is accepted as the login form. If the expression does not match any form on the page, an error may be returned to the client browser reporting that the requested form could not be found.

The “sso-resource” specifies an single-sign-on database resource that may be used when retrieving a username/password combination from an authentication database; if unused, it may be left blank.

The “argument-stanza” points to another custom stanza that lists the fields and data that are required when completing the login form, i.e., which contains the parameters to the authentication request. The value of the “name” parameter is the name of the input to send, i.e., it is set to equal the value of the “name” attribute of the HTML “input” tag. This parameter could also use the value of the “name” attribute of the HTML “select” or “textarea” tags. The “method:value” parameter combination retrieves the authentication data that is required by the form, i.e., it is a rule that determines the value of the “name” parameter. Several different kinds of argument values may be used, such as username/password combinations or other user attribute information from an authentication database.

With reference now to FIG. 5, a block diagram depicts an embodiment of the present invention in which a web server plug-in incorporates one or more modules for providing functionality for forms-based single-sign-on operations. In a manner similar to FIG. 3, enterprise domain 500 hosts controlled resources that a user can access, e.g., by using a browser application on a client device via a network. Application servers support accessible resources through web-based applications or other types of applications.

In this embodiment, web server 502 hosts forms-based single-sign-on (FSSO) plug-in 504, which comprises three modules. Alternatively, the forms-based single-sign-on functionality could be incorporated into a single module.

As another alternative, the modules could be incorporated into a different type of plug-in. The modules may be distributed in the form of a set of library routines, a set of class files, etc. FSSO plug-in 504 comprises FSSO post-authorization module 506, FSSO response module 508, and FSSO pre-authorization module 510. These modules operate in close cooperation with authorization server 512 as explained in more detail below.

In general, FSSO plug-in 504 in FIG. 5 accomplishes the same goal as FSSO unit 322 in FIG. 3. When a user of the client has already been authenticated and a web application requires completion of an HTML form for authentication before servicing the client's requests, FSSO plug-in 504 allows web servers or web plug-ins to transparently login a client. Existing single-sign-on methodologies perform a similar function but only work in cases in which the web application and the plug-in share an understanding of some additional payload added to the client's original request which indicates that the client has already been authenticated by another trusted application. With FSSO plug-in 504, the client request for an HTML login form is trapped en route, allowing the plug-in to complete the form and its associated authentication operation, thereby resulting in a first hand authentication of the client at the web application.

The FSSO module is responsible for handling the authorization server processing for a plug-in. The module will export three module interfaces, a pre-authorization interface, a post-authorization interface, and a response interface. The post-authorization module provides an interface that performs the following actions: intercepts requests to nominated web pages that are assumed to be redirected requests for login forms; requests the web server plug-in to capture the returned login form; and save information about the original request in the current session.

The response module provides an interface that performs the following actions: receives a captured login form from the web server plug in; redirects the client browser to an FSSO interlude page; and saves information about the captured web page in the current session. The pre-authorization module provides an interface that performs the following actions: intercepts (redirected) requests to an FSSO interlude page; retrieves information from the current session to build a response to the login form, thereby replacing the request for the interlude page and posting it to the login form handler's URI.

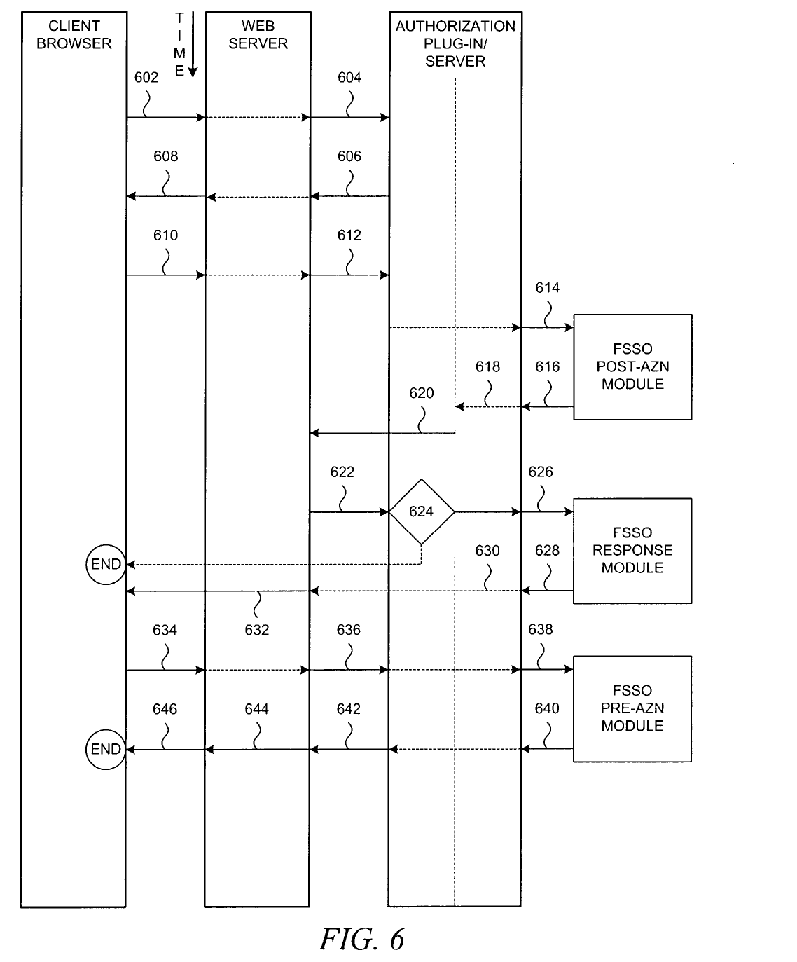

With reference to FIG. 6, a dataflow diagram depicts the flow of information of a plug-in embodiment for the FSSO functionality. The operations of the plug-in and the authorization server are tightly integrated, so for convenience of illustration, the plug-in and the authorization server are shown together. The process in FIG. 6 assumes that the user has already completed an authentication process.

The process begins with the client browser requesting a page protected by a web application's forms login page (step 602). The web plug-in authorizes access to requested page (step 604) and returns the unmodified request to the web server (step 606). The web server application decides that a forms-based login is required and sends a redirect to browser (step 608). The browser requests the forms-based login page (step 610), and the web server passes the request for the login page to the plug-in/authorization server (step 612). Up to this point, all processing has been standard processing, and no forms-based single-sign-on specific intervention has occurred.

The authorization server then checks access to the login page as usual and passes the request to the forms-based single-sign-on (FSSO) post-authorization (post-azn) module (step 614). If the result of the authorization check indicates that the request should not be permitted, then an error is returned. If the client is unauthenticated, no further intervention occurs, as the servers do not hold any values with which to complete the login form. In that case, the form will be served to the client browser as normal.

For authenticated users, the post-azn module examines the requested page, and if the post-azn module recognizes that the requested page is a login page of interest, e.g., based on information loaded from the FSSO configuration data, all of the headers and cookies sent in the request are saved in temporary storage and a new plug-in protocol command is added to the request to capture the response. The post-azn module then returns the transaction to the authorization server (step 616).

The authorization server returns the transaction to the plug-in at the web server (step 618). The body of the request has not been modified at this stage, although an FSSO capture response command may have been added to the proxy message for targeted URI's. The plug-in then acts on any capture response command (step 620). Actions for this step would be specific to the web-server environment. The plug-in performs the necessary steps to setup for interception of the yet to be served login form and returns the request to the web server to continue with the otherwise unaltered processing of the login page, i.e. the completion of any more path check and service handling phases.

The web server responds with the login form (step 622), and if the plug-in was instructed to capture the response, then the intercepted page is sent to the authorization server (step 624); otherwise, the response is returned normally to the client browser, thereby ending the forms-based single-sign-on functionality.

The authorization server then passes the captured form to the FSSO response module (step 626). The response module stores it along with all associated headers and cookies. The response to the client is replaced with a redirect to the FSSO sign-on page. The FSSO module returns the updated transaction to the authorization server (step 628), and the authorization server passes the new response back to the web server (step 630).

The web server then responds with the redirect to the client browser with the redirect (step 632). The browser requests the FSSO sign-on page to which it was redirected (step 634). The web server passes the request to the plug-in authorization server (step 636), and the authorization server passes the request to the FSSO pre-authorization (pre-azn) module (step 638). The FSSO pre-azn module recognizes that the request is for an internal FSSO redirected sign-on page; it retrieves the application login page stored in step 628 and parses the HTML to identify the request method, the action URI, and any other input fields in the form. If the FSSO configuration file specifies the action URI of the login form via a regular expression, then FSSO finds the first form in the page whose action URI matches the regular expression. Otherwise, FSSO finds the first HTML form in the page. The method for the request is the one specified by the login form.

The FSSO module replaces the request for the FSSO internal page, builds a response to the web application's login form, and returns the response to the plug-in (step 640). The URI for the request is the action URI from the form, relative to any BASEURL tags specified in the document. The cookies in the request are a combination of the cookies saved from step 614 and step 628. In the case that two cookies have the same name, the cookie from step 628 takes precedence. If the method for the HTTP request is POST, then the value of the “Content-type” header would be “x-www-form-urlencoded”; otherwise, no “Content-type” header would be sent. If the method for the request is POST, then the value of the “Content-length” header would be the length of the arguments. The value of the “Referer” header would be the absolute URI of the login page. The host name in the absolute URI would be the name of the application server. The other HTTP headers in the request are the headers from step 614.

The arguments to the authentication request are as follows. If an argument was specified in the configuration file, then its value is the value from the configuration file. Otherwise, the arguments used are the arguments retrieved from the login form in step 638. If the arguments were gathered by parsing the login form, then the order in which the arguments would be sent to the application server would be the order in which they were received by the plug-in. Otherwise, the order of the arguments will be their order from the configuration file. If arguments specified in the configuration file are not found in the login form, then those arguments would be the last arguments sent to the application.

The authorization server returns the constructed authorization request to the web server (the post) (step 642). Because the request was replaced during pre-authorization processing, the constructed URI would be checked as usual for access permission by the authorization server. It is possible access permission would be denied at this stage, and the filled-in form would not be posted. The web server application then receives the authorization request and continues as if the request that was sent at step 634 was the result of the user interactively completing the login form (step 644).

The browser receives the result of the login (step 646). The plug-in does not attempt to capture the result of the login attempt. If the login is successful, the application may send a welcome screen or possibly a redirect to the page originally requested in step 602. If the result of the login attempt was a failure, then the web application's own error is returned to the browser, and it is not intercepted or manipulated by the plug-in.

The user experience at the browser is of a single request for a page, followed by a single response that is either successful completion or a failure to login. A failure could be caused by either the web plug-in not supplying the correct username/password information, which is an error of configuration/administration, or because the user fails some policy of the web login application, e.g., out of hours access.

No provision is made within the web plug-in for the client to retry the login with a different username/password combination following a failure of automated login. In order for the client to bypass the FSSO processing, it would be necessary for the user to start a new unauthenticated client session and re-access the target page, resulting in the login form being served directly to the unauthenticated user to fill-in, assuming of course that access was granted to unauthorized users by an imposed authorization policy.

The advantages of the present invention should be apparent in view of the detailed description of the invention that is provided above. Web-based applications typically utilize various means to prompt users to enter authentication information, usually as a username/password combination via an HTML form.

In one embodiment of the present invention, a proxy server sits between multiple back-end applications that are hosted by a given domain and a user of resources at that domain. At some point in time, a back-end application attempts to send an authentication form to the user in order to obtain authentication information for an authentication operation. Using the forms-based single-sign-on mechanism of the present invention, the proxy server intercepts the attempt to send the authentication form to the user. Assuming that the user has already been authenticated-within the proxy server's computing environment, the proxy server automatically logs a user into the back-end application in a single-sign-on fashion instead of sending the authentication form to the user. In an alternative embodiment, a web server plug-in accomplishes a similar forms-based single-sign-on operation.

The present invention is directed only to applications that use a form-based authentication method. The form documents may comprise a wide variety of formats, however, and the present invention has flexibility to accommodate a wide variety of form documents through its configurable options. The present invention also properly handles HTTP cookies, HTML hidden form fields, and various other elements of HTTP transactions.

The present invention is operable with a wide variety of back-end applications for many reasons. For example, the present invention does not inquire into the necessity of the back-end application's authentication process; if the back-end application determines that an authentication process is required, then the back-end application is allowed to proceed with its own authentication process without approval from some other authentication process. In addition, the back-end application is not required to be modified to interface with other authentication processes.

Although a similar advantage is available through other single-sign-on mechanisms, a significant advantage of the present invention is that it provides a single point of authentication within a network, which is administratively efficient. Users are also more efficient because a user only has to prove identity once, and the user may then access other controlled resources without having to pass another authentication challenge. In addition, applications do not need to be modified to incorporate application programming interfaces (APIs) in order to participate in this single-sign-on functionality, thereby simplifying deployment of applications.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for providing single-sign-on functionality in a data processing system, the method comprising:
authenticating a user through a first server-side authentication operation;
detecting at a server an attempt by a server-side application to initiate a second server-side authentication operation with the user;
receiving a form document at the server from the server-side application; and
returning from the server to the server-side application a form response on behalf of the user.

2. The method of claim 1 wherein the step of returning a form response further comprises:
determining input fields in the form document;
retrieving authentication information for the user in accordance with the determined input fields;
generating an authentication response comprising the retrieved authentication information; and
sending the authentication response to the server-side application in order to complete the second server-side authentication operation.

3. The method of claim 2 wherein the generating step is performed by a server plug-in.

4. The method of claim 1 wherein the server is a proxy server.

5. The method of claim 1 wherein the detecting step further comprises:
determining a URI (Uniform Resource Identifier) in a message received from a client that is operated by the user.

6. The method of claim 1 wherein the detecting step further comprises:
determining an identifier in the form document in a message received from the server-side application.

7. The method of claim 1 further comprising:
obtaining filtering parameters from a configuration file at the server; and
filtering incoming requests and/or outgoing responses at the server in accordance with the filtering parameters in order to detect the second server-side authentication operation.

8. An apparatus for providing single-sign-on functionality, the apparatus comprising:
means for authenticating a user through a first server-side authentication operation;
means for detecting at a server an attempt by a server-side application to initiate a second server-side authentication operation with the user;
means for receiving a form document at the server from the server-side application; and
means for returning from the server to the server-side application a form response on behalf of the user.

9. The apparatus of claim 8 wherein the means for returning a form response further comprises:
means for determining input fields in the form document;
means for retrieving authentication information for the user in accordance with the determined input fields;
means for generating an authentication response comprising the retrieved authentication information; and
means for sending the authentication response to the server-side application in order to complete the second server-side authentication operation.

10. The apparatus of claim 9 wherein the generating means is within a server plug-in.

11. The apparatus of claim 8 wherein the server is a proxy server.

12. The apparatus of claim 8 wherein the detecting means further comprises:
means for determining a URI (Uniform Resource Identifier) in a message received from a client that is operated by the user.

13. The apparatus of claim 8 wherein the detecting means further comprises:
means for determining an identifier in the form document in a message received from the server-side application.

14. The apparatus of claim 8 further comprising:
means for obtaining filtering parameters from a configuration file at the server; and
means for filtering incoming requests and/or outgoing responses at the server in accordance with the filtering parameters in order to detect the second server-side authentication operation.

15. A computer program product in a computer readable medium for providing single-sign-on functionality within a data processing system, the computer program product comprising:
means for authenticating a user through a first server-side authentication operation;
means for detecting at a server an attempt by a server-side application to initiate a second server-side authentication operation with the user;
means for receiving a form document at the server from the server-side application; and
means for returning from the server to the server-side application a form response on behalf of the user.

16. The computer program product of claim 15 wherein the means for returning a form response further comprises:
means for determining input fields in the form document;
means for retrieving authentication information for the user in accordance with the determined input fields;
means for generating an authentication response comprising the retrieved authentication information; and
means for sending the authentication response to the server-side application in order to complete the second server-side authentication operation.

17. The computer program product of claim 16 wherein the generating means is within a server plug-in.

18. The computer program product of claim 15 wherein the server is a proxy server.

19. The computer program product of claim 15 wherein the detecting means further comprises:
means for determining a URI (Uniform Resource Identifier) in a message received from a client that is operated by the user.

20. The computer program product of claim 15 wherein the detecting means further comprises:
means for determining an identifier in the form document in a message received from the server-side application.

21. The computer program product of claim 15 further comprising:
means for obtaining filtering parameters from a configuration file at the server; and
means for filtering incoming requests and/or outgoing responses at the server in accordance with the filtering parameters in order to detect the second server-side authentication operation.
